(19) United States
(12) Patent Application Publication
(10) Pub. No.: US 2023/0401777 A1
(43) Pub. Date: Dec. 14, 2023

(54) METHOD AND APPARATUS FOR CREATING AVATAR BASED ON BODY SHAPE

(71) Applicant: IdeaLink Inc., Seoul (KR)

(72) Inventor: Jong Min KIM, Seoul (KR)

(73) Assignee: IdeaLink Inc., Seoul (KR)

(21) Appl. No.: 18/315,225

(22) Filed: May 10, 2023

(30) Foreign Application Priority Data
Jun. 8, 2022 (KR) 10-2022-0069460

(51) Int. Cl. G06T 13/40; G06T 7/50; G06T 7/70; G06T 7/20; G06T 19/20

(52) U.S. Cl. CPC G06T 13/40; G06T 7/50; G06T 7/70; G06T 7/20; G06T 19/20; G06T 2207/30196; G06T 2219/2021

(57) ABSTRACT

Disclosed herein is a method for creating, by at least one server, an avatar based on a body shape, including acquiring first image information from a user terminal, deriving first skeleton information corresponding to a first pose of a user from the first image information, deriving body shape information corresponding to an outline of the user from the first image information, and creating a three-dimensional (3D) avatar corresponding to a body shape of the user based on possible human body movement information stored in a database, the first skeleton information, and the body shape information.

### CROSS-REFERENCE TO RELATED APPLICATION

This application claims priority to and the benefit of Korean Patent Application No. 10-2022-0069460, filed on Jun. 8, 2022, the disclosure of which is incorporated herein by reference in its entirety.

### BACKGROUND

### 1. Field of the Invention

The present disclosure relates to a method and apparatus for creating an avatar based on a body shape, and more particularly, to a method and apparatus for creating an avatar reflecting a user's current body shape using a body shape, and for providing services related to the user's body shape or movement using the created avatar.

### 2. Description of the Related Art

Recently, many methods have been developed to detect a user's movement to move a specific character or recognize an operation on a specific image. However, in general, the appearances of specific characters are preset, and only certain parts of the user's body are recognized to move a specific character.

In this case, the user can identify a specific character that moves along with his or her movements. However, the character has a completely unrelated appearance to the user's own, making it difficult for the user to immerse themselves in the experience or feel emotionally involved. In addition, as virtual reality-related technologies are rapidly evolving, there are discussions on how to provide customized avatars or characters that reflect the user's body or preferences with fewer resources.

### SUMMARY OF THE INVENTION

Therefore, the present disclosure has been made in view of the above problems, and it is an object of the present disclosure to provide a method for creating an avatar based on a body shape.

It is another object of the present disclosure to provide an apparatus for creating an avatar based on a body shape.

In accordance with the present disclosure, the above and other objects can be accomplished by the provision of a method for creating, by at least one server, an avatar based on a body shape. The method may include acquiring first image information from a user terminal, deriving first skeleton information corresponding to a first pose of a user from the first image information, deriving body shape information corresponding to an outline of the user from the first image information, and creating a three-dimensional (3D) avatar corresponding to a body shape of the user based on possible human body movement information stored in a database, the first skeleton information, and the body shape information.

Here, the creating the 3D avatar corresponding to the body shape of the user may include creating a temporary avatar corresponding to the first pose of the user based on the first skeleton information from the possible human body movement information, and creating the 3D avatar corresponding to the body shape of the user based on the body shape information and the temporary avatar.

The method may further include acquiring second image information from the user terminal, deriving second skeleton information corresponding to a second pose of the user from the second image information, and controlling a pose of the 3D avatar based on the second skeleton information.

Here, the controlling the pose of the 3D avatar based on the second skeleton information may include creating a movement of the 3D avatar from a pose of the 3D avatar according to the first skeleton information to the pose of the 3D avatar according to the second skeleton information based on the possible human body movement information.

In accordance with another aspect of the present disclosure, provided is a server for performing a body shape-based avatar creation method, the server including a processor and a memory configured to store at least one instruction executed by the processor, wherein the at least one instruction may be executed to acquire first image information from a user terminal, executed to derive first skeleton information corresponding to a first pose of a user from the first image information, executed to derive body shape information corresponding to an outline of the user from the first image information, and executed to create a three-dimensional (3D) avatar corresponding to a body shape of the user based on possible human body movement information stored in a database, the first skeleton information, and the body shape information.

Here, the at least one instruction may be executed to create a temporary avatar corresponding to the first pose of the user based on the first skeleton information from the possible human body movement information, and executed to create the 3D avatar corresponding to the body shape of the user based on the body shape information and the temporary avatar.

The at least one instruction may be executed to acquire second image information from the user terminal, executed to derive second skeleton information corresponding to a second pose of the user from the second image information, and executed to control a pose of the 3D avatar based on the second skeleton information.

The at least one instruction may be executed to create a movement of the 3D avatar from a pose of the 3D avatar according to the first skeleton information to the pose of the 3D avatar according to the second skeleton information based on the possible human body movement information.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram of an apparatus for creating an avatar based on a body shape, according to an embodiment of the present disclosure;

FIG. 2 is a diagram illustrating terminals on which a body shape-based avatar creation method according to an embodiment of the present disclosure is executed;

FIG. 3 is a flowchart of a body shape-based avatar creation method according to an embodiment of the present disclosure;

FIG. 4 is a diagram illustrating an avatar creation process according to an embodiment of the present disclosure; and

FIG. 5 is a diagram illustrating a method of checking body shape changes through a 3D avatar according to an embodiment of the present disclosure.

### DETAILED DESCRIPTION OF THE INVENTION

The present disclosure may be subjected to various changes and may have various embodiments, and specific embodiments will be described in detail with reference to the accompanying drawings. However, this is not intended to limit the present disclosure to any specific embodiment and is to be understood as including all modifications, equivalents, or substitutions that fall within the spirit and scope of the present disclosure. Wherever possible, like reference numerals will be used throughout the drawings to refer to the same or like parts.

Terms such as first, second, A, and B may be used to describe various components, but the components are not to be limited by such terms. These terms are used only to distinguish one component from another. For example, without departing from the scope of the present disclosure, a first component may be named as a second component, and similarly, a second component may be named as a first component. The term “and/or” includes any combination of a plurality of related recited items or any one of the pluralities of related recited items.

When a component is referred to as being “connected” or “coupled” to another component, it is to be understood that it may be directly connected or coupled to the other component, but that there may be other components between the components. On the other hand, when a component is referred to as being “directly connected” or “directly coupled” to another component, it is to be understood that there are no other components between the components.

The terminology employed in this specification is merely used to describe specific embodiments and is not intended to limit the present disclosure. A singular expression includes a plural expression unless the context clearly dictates otherwise. In this specification, the term “include” or “have” is intended to indicate that characteristics, figures, steps, operations, constituents, and components disclosed in the specification or combinations thereof exist. The term “include” or “have” should be understood as not pre-excluding possibility of existence or addition of one or more other characteristics, figures, steps, operations, constituents, components, or combinations thereof.

Unless defined otherwise, all terms used herein, including technical or scientific terms, have the same meaning as commonly understood by one of ordinary skill in the art to which this invention belongs. Terms such as those defined in commonly used dictionaries should be interpreted as having a meaning that is consistent with their meaning in the context of this specification and the relevant art and will not be interpreted in an idealized or overly formal sense unless expressly so defined herein.

Hereinafter, preferred embodiments of the present disclosure will be described in more detail with reference to the accompanying drawings. In describing the present disclosure, the same reference numerals are assigned to the same components in the drawings to provide a thorough understanding, and redundant description of the same components is omitted.

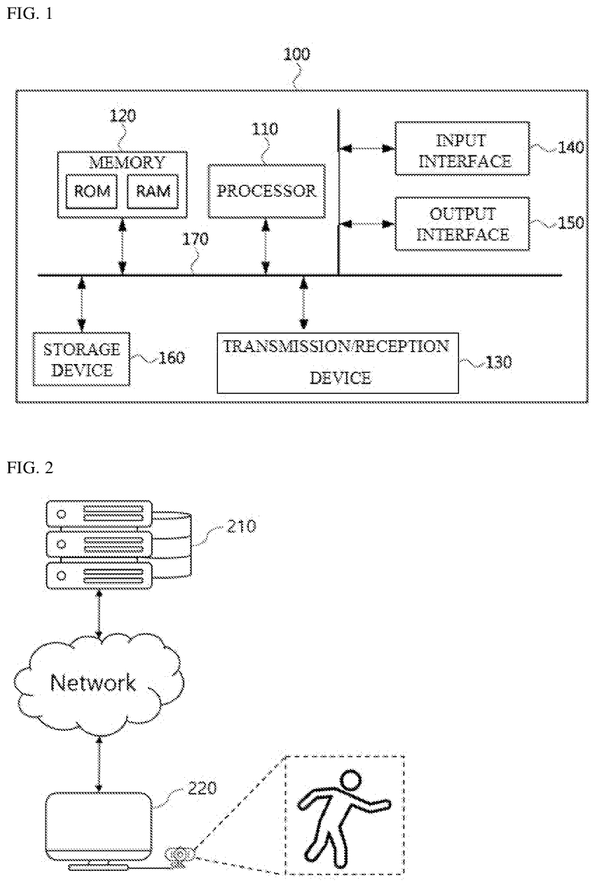

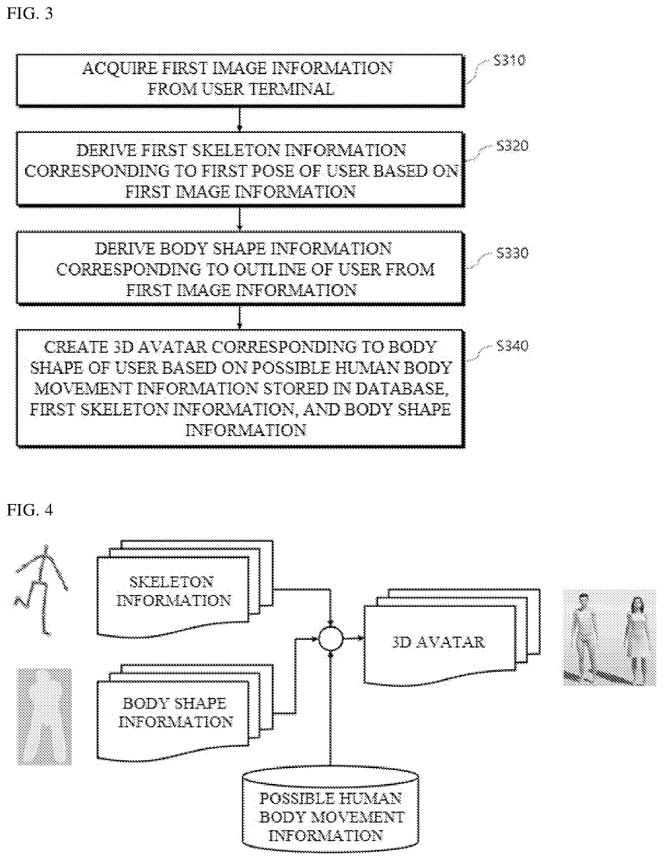

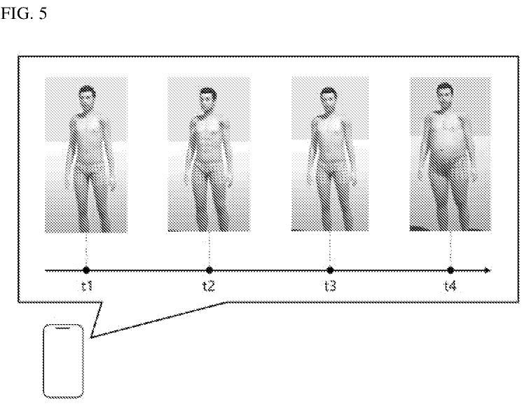

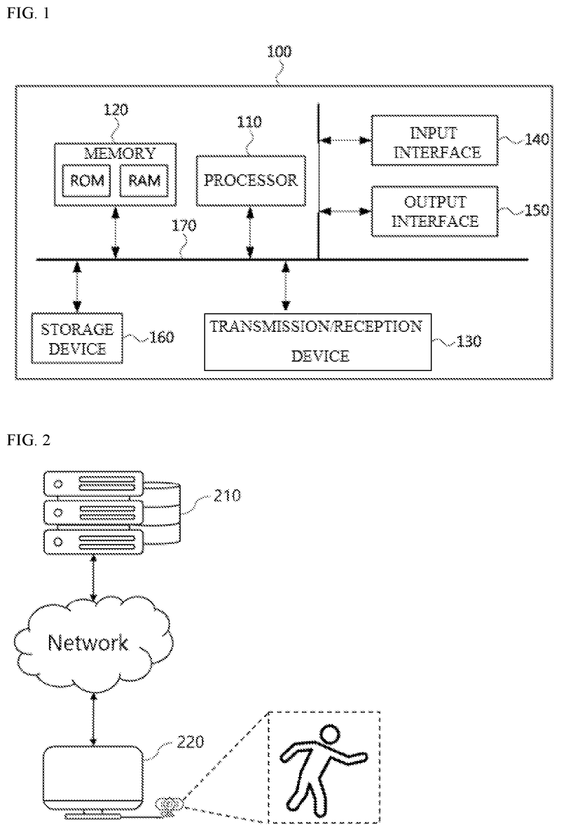

FIG. 1 is a block diagram of an apparatus for creating an avatar based on a body shape, according to an embodiment of the present disclosure.

For example, at least one processor 110 may refer to a central processing unit (CPU), a graphics processing unit (GPU), or a dedicated processor on which methods according to embodiments of the present disclosure are executed. Each of a memory 120 and a storage device 160 may include at least one of a volatile storage medium and a non-volatile storage medium. For example, the memory 120 may be one of a read only memory (ROM) and a random-access memory (RAM), and the storage device 160 may be a flash-memory, a hard disk drive (HDD), a solid-state drive (SSD), or various memory cards (e.g., a micro SD card).

For example, the memory 120 or storage device 160 may store at least one instruction that may be executed by the at least one processor 110. For example, the at least one instruction may include an instruction to acquire first image information from a user terminal, an instruction to derive first skeleton information corresponding to a first pose of a user from the first image information, an instruction to derive body shape information corresponding to an outline of the user from the first image information, and an instruction to create a 3D avatar corresponding to a body shape of the user based on possible human body movement information stored in a database, the first skeleton information, and the body shape information.

For example, the instruction to create a 3D avatar corresponding to the body shape of the user may include an instruction to create a temporary avatar corresponding to the first pose of the user based on the first skeleton information from the possible human body movement information, and an instruction to create a 3D avatar corresponding to the body shape of the user based on the body shape information and the temporary avatar.

For example, the at least one instruction may further include an instruction to acquire a second image information from the user terminal, an instruction to derive second skeleton information corresponding to a second pose of the user from the second image information, and an instruction to control a pose of the 3D avatar based on the second skeleton information.

For example, the instruction to control the pose of the 3D avatar based on the second skeleton information may include an instruction to create a movement of the 3D avatar from a pose of the 3D avatar according to the first skeleton information to a pose of the 3D avatar according to the second skeleton information based on the possible human body movement information.

FIG. 2 is a diagram illustrating terminals on which a body shape-based avatar creation method according to an embodiment of the present disclosure is executed.

Referring to FIG. 2, the body shape-based avatar creation method according to one embodiment of the present disclosure may be executed via wired or wireless communication between a body shape-based avatar creation server (hereinafter, server) 210 and a user terminal 220. Here, the body shape-based avatar creation server 210 may represent the body shape-based avatar creation apparatus described above.

The user terminal 220 may represent a communicable, computationally capable electronic device, such as, for example, a communicable desktop computer, laptop computer, notebook, smartphone, tablet PC, mobile phone, smart watch, smart glass, e-book reader, portable multimedia player (PMP), portable gaming device, navigation device, digital camera, digital multimedia broadcasting (DMB) player, digital audio recorder, digital audio player, digital video recorder, digital video player, or personal digital assistant (PDA).

The user terminal 220 may be an electronic device equipped with a recording device for recording images of a user's pose, appearance, or movement, but is not limited thereto. It may receive images of a movement of the user over a network.

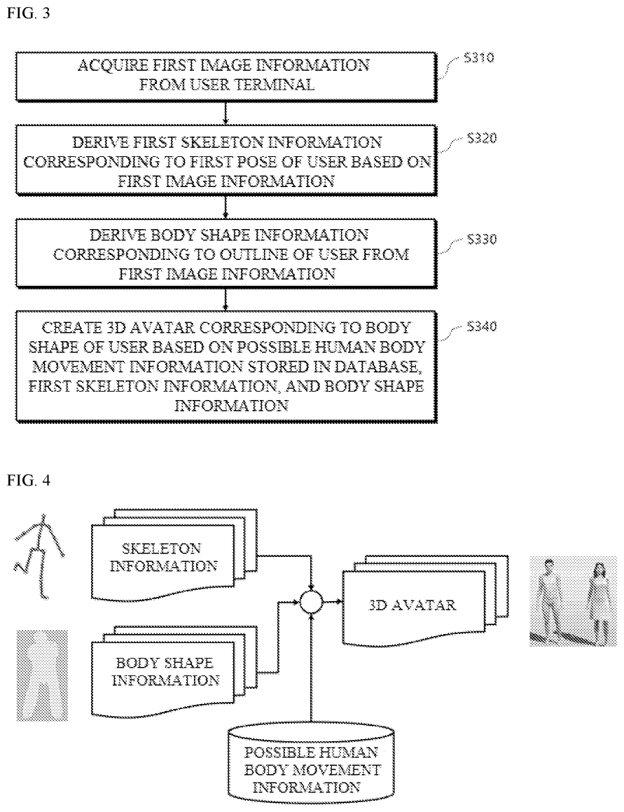

FIG. 3 is a flowchart of a body shape-based avatar creation method according to an embodiment of the present disclosure.

Referring to FIG. 3, in operation S310, the server may acquire first image information from a user terminal. Here, the first image information may be information about an image containing an appearance of a user. It may be acquired through an image capture device mounted on the user terminal, or may be acquired from another external server or another user terminal over a network.

In operation S320, the server may derive first skeleton information corresponding to a first pose of the user from the first image information. That is, the first image information may include an image containing an appearance of the user in a specific pose, and the server may derive skeleton information about the specific pose of the user from the image.

For example, the skeleton information may include information about joints representing articulated portions or edges of the user's body and information about lines between the joints. For example, the articulated portions or edge portions corresponding to the joints may include at least one of nose, left_eye, right_eye, left_ear, right_ear, left_shoulder, right_shoulder, left_elbow, right_elbow, left_wrist, right_wrist, left_hip, right_hip, left_knee, right_knee, left_ankle, right_ankle, club_handle, and club_head.

Also, a pre-trained skeleton extraction model may be used to derive the skeleton information. That is, the server may derive the skeleton information from the image information based on the pre-trained skeleton extraction model. The skeleton extraction model may be pre-trained through machine learning by organizing the image information for training and the skeleton information for training corresponding to the image information for training into a training data set. The algorithm used for machine learning may be a deep neural network (DNN), a convolutional neural network (CNN), a recurrent neural network (RNN), a restricted Boltzmann machine (RBM), or a deep belief network (DBN), but other algorithms more suitable for learning may be used. Each of the algorithms is well known in the art, and thus will not be described below. The skeleton information described above may represent the first skeleton information described above or second skeleton information described below.

In operation S330, the server may derive body shape information corresponding to an outline of the user from the first image information. That is, the server may extract or detect the outline of the user in a specific pose from the image, and may derive the body shape information about the user based on the outline.

For example, the body shape information may include information about an area occupied by the user's body in the image, and a pre-trained body outline extraction model may be used to derive the body shape information. That is, the server may derive the body shape information from the image information based on the pre-trained body outline extraction model. Here, the body outline extraction model may be pre-trained through machine learning by configuring the image information for training and the body shape information for training corresponding to the image information for training as a training data set, and the algorithm used for machine learning may include various algorithms such as the skeleton extraction model. The algorithm used for the skeleton extraction model and the algorithm used for the body outline extraction model may differ from each other in consideration of efficiency.

In operation S340, the server may create a 3D avatar corresponding to the body shape of the user based on possible human body movement information stored in a database, the first skeleton information, and the body shape information. A more detailed description will be given hereinafter with reference to FIG. 4.

FIG. 4 is a diagram illustrating an avatar creation process according to an embodiment of the present disclosure.

Referring to FIG. 4, the server may create a 3D avatar reflecting the user's body shape based on the possible human body movement information, the first skeleton information, and the body shape information.

For example, the possible human body movement information stored in the database may include muscle and appearance information about possible movements of the human body based on the structure of the human body. For example, the possible human body movement information may be stored by acquiring 2D or 3D character movement information from another external server and storing or further processing the same. However, embodiments are not limited thereto. The possible human body movement information may be acquired by other means.

For example, the server may derive avatar information reflecting the body shape of the user from the possible human body movement information stored in the database based on the derived body shape information, and may create an avatar based on the derived avatar information. Alternatively, for example, the server may create a temporary avatar by deriving temporary avatar information corresponding to a first pose of the user from the possible human body movement information using the first skeleton information, and may create a 3D avatar by reflecting the body shape of the user in the temporary avatar based on the temporary avatar information and the body shape information. Alternatively, for example, the server may derive avatar information reflecting the user's body shape based on the body shape information. However, in the case where it is difficult to derive accurate body shape information due to overlapping parts of the user's body, the server may create a 3D avatar through the above-described process based on the first skeleton information. For example, when the shapes of the user's arms and legs are not identified in the shapes according to the body shape information, the server may determine that some parts of the body are overlapping, making it difficult to derive accurate body shape information, but the scope of the present disclosure is not limited to this method of determination. Other methods may also be used.

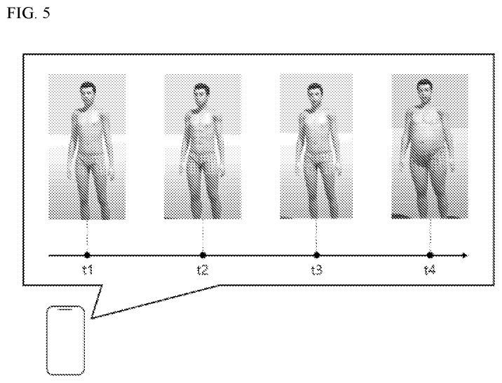

FIG. 5 is a diagram illustrating a method of checking body shape changes through a 3D avatar according to an embodiment of the present disclosure.

Referring to FIG. 5, in one embodiment, a user may create 3D avatars reflecting the body shape of a user created as described above at multiple time points t1, t2, t3, and t4 and compare the same to easily identify any changes in the user's body shape.

For example, the 3D avatars created at different time points may be stored as still images and provided to the user terminal, respectively. Alternatively, for example, in one embodiment, a single video including a single 3D avatar that gradually changes over time in a chronological order may be created based on the 3D avatars created at different time points, each stored as a still image, and may be stored and provided via the user terminal. For example, in creating a single video, the user may select at least some of a plurality of time points on the user terminal, and the server may create a single video including a single 3D avatar based on the 3D avatars corresponding to the selected at least some of the time points in a chronological order of the at least some of the time points. The selected at least some of the time points may be consecutive time points in a chronological order of the time points at which the 3D avatar is created among the plurality of time points, or may be selected as non-consecutive time points such that changes in body shape are clearly visible.

According to another embodiment, the server may control the pose of the created 3D avatar based on the movement of the user. For example, the server may acquire second image information from the user terminal. The second image information may be an image that includes a different appearance of the user. Then, the server may derive second skeleton information corresponding to a second pose of the user from the second image information in the same manner as deriving the first skeleton information, and may control the pose of the created 3D avatar based on the second skeleton information.

For example, the pose control of the 3D avatar may create a movement of the 3D avatar from the pose of the 3D avatar according to the first skeleton information to the pose of the 3D avatar according to the second skeleton information based on the possible human body movement information. In other words, the server may create an intermediate pose or intermediate movement between the pose of the 3D avatar according to the first skeleton information and the pose of the 3D avatar according to the second skeleton information based on the possible human body movement information, and may smoothly control and provide the movement of the 3D avatar based thereon. For example, the intermediate pose or intermediate movement of the 3D avatar may be created and provided only when the difference between the pose of the 3D avatar according to the first skeleton information and the pose of the 3D avatar according to the second skeleton information is above a specific level. Whether the difference is above the specific level may be determined based on the difference in distance between the joints contained in the skeleton information used in creating the 3D avatar.

In other embodiments, when a user performs an activity, such as sports or dance, the movement of the 3D avatar may be created by controlling the posture of the 3D avatar as described above in response to the user's movements, and images thereof may be stored or uploaded to another external server. Further, the user may be allowed to easily share his or her movements with others.

According to another embodiment, the server may virtually create and provide to the user appearances corresponding to cases where the weight of the 3D avatar is reduced or increased based on the created 3D avatar reflecting the user's body shape and the possible human body movement information (or the temporary avatar). In other words, user may provide an input to decrease or increase the weight within a specific range for the created 3D avatar on the user terminal, and the server may adjust the body shape of the 3D avatar based on the input, and may create and provide the adjusted 3D avatar. In addition, according to another embodiment, the user may also provide an input to decrease or increase the amount of muscle or the age value within a specific range for the created 3D avatar on the user terminal, such as changing the weight, and the server may adjust the body shape or appearance of the 3D avatar based on the input, and create and provide the adjusted 3D avatar. In order to make the above changes or adjustments, the server may acquire the user's current weight, current muscle mass, or current age value through the user terminal, and may use the acquired information as a basis for making the changes or adjustments.

The operations according to embodiments of the present disclosure may be implemented as a computer-readable program or code on a computer-readable recording medium. The computer-readable recording medium includes any kind of recording device on which data is stored that may be read by a computer system. The computer-readable recording medium may also be distributed across networked computer systems, where the computer-readable program or code may be stored and executed in a distributed manner.

When embodiments are implemented in software, the techniques described above may be implemented as modules (procedures, functions, etc.) that perform the functions described above. The modules may be stored in a memory and executed by a processor. The memory may be located inside or outside the processor, and may be coupled to the processor by various well-known means.

The computer-readable recording medium may also include hardware devices specifically configured to store and execute program instructions, such as a ROM, RAM, flash memory, or the like. The program instructions may include machine language code, such as that created by a compiler, as well as high-level language code that may be executed by a computer using an interpreter or the like.

Although some aspects of the present disclosure have been described in the context of a device, it may also be described according to a corresponding method, where the blocks or devices correspond to method steps or features of the method steps. Similarly, aspects described in the context of a method may also be represented by corresponding blocks or items or features of corresponding devices. Some or all of the method steps may be performed by (or using) hardware devices, such as, for example, microprocessors, programmable computers, or electronic circuits. In some embodiments, one or more of the most important steps of the method may be performed by such devices.

In embodiments, programmable logic devices (e.g., field programmable gate arrays) may be used to perform some or all of the functions of the methods described herein. In embodiments, a field programmable gate array may operate in conjunction with a microprocessor to perform one of the methods described herein. In general, the methods are preferably performed by any hardware device.

As is apparent from the above description, the present disclosure provides the following effects.

According to the present disclosure, a 3D avatar reflecting a user's body shape may be created and provided without the need for many cameras.

According to the present disclosure, body shape changes over time may be checked using a 3D avatar and easily shared with others without direct exposure.

The solutions to the problems are not limited to those described above, and solutions not mentioned will be apparent to one of ordinary skill in the art to which this application belongs from this specification and the accompanying drawings.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A method for creating, by at least one server, an avatar based on a body shape, the method comprising:
acquiring first image information from a user terminal;
deriving first skeleton information corresponding to a first pose of a user from the first image information;
deriving body shape information corresponding to an outline of the user from the first image information; and
creating a three-dimensional (3D) avatar corresponding to a body shape of the user based on possible human body movement information stored in a database, the first skeleton information, and the body shape information.

2. The method of claim 1, wherein the creating the 3D avatar corresponding to the body shape of the user comprises:
creating a temporary avatar corresponding to the first pose of the user based on the first skeleton information from the possible human body movement information; and
creating the 3D avatar corresponding to the body shape of the user based on the body shape information and the temporary avatar.

3. The method of claim 1, further comprising:
acquiring second image information from the user terminal;
deriving second skeleton information corresponding to a second pose of the user from the second image information; and
controlling a pose of the 3D avatar based on the second skeleton information.

4. The method of claim 3, wherein the controlling the pose of the 3D avatar based on the second skeleton information comprises:
creating a movement of the 3D avatar from a pose of the 3D avatar according to the first skeleton information to the pose of the 3D avatar according to the second skeleton information based on the possible human body movement information.
